(19) United States
(12) Patent Application Publication
(10) Pub. No.: US 2015/0020511 A1
(43) Pub. Date: Jan. 22, 2015

(54) METHOD FOR ENERGY RECOVERY OF HYDRAULIC MOTOR

(71) Applicant: Caterpillar Inc., Peoria, IL (US)

(72) Inventors: TIMOTHY L. HAND, METAMORA, IL (US); RANDALL A. HARLOW, BRIMFIELD, IL (US); DAVID T. GUETSCHOW, EAST PEORIA, IL (US)

(73) Assignee: Caterpillar Inc., Peoria, IL (US)

(21) Appl. No.: 14/510,139

(22) Filed: Oct. 9, 2014

(51) Int. Cl. F15B 21/14; F16H 39/02

(52) U.S. Cl. CPC F15B 21/14; F16H 39/02
USPC 60/327; 60/414

(57) ABSTRACT

A method to recover energy in a reversible hydraulic motor system during a motor reverse event is disclosed. A swashplate of a hydraulic motor is pivoted over a center position when the hydraulic motor rotates in a first direction and is due to receiving a pressurized fluid from a pump. Thereafter, by de-stroking the pump a pressurized fluid to the hydraulic motor is restricted. Then, a valve is moved to a charge position to store the pressurized fluid into an accumulator. Next, the stored pressurized fluid of the accumulator is discharged to the hydraulic motor as the hydraulic motor begins rotation in an opposite, second direction. Subsequently, the valve is moved to a block position to inhibit flow of the pressurized fluid into or out of the accumulator. By up-stroking the pump, a continuous rotation of the hydraulic motor in the opposite, second direction is maintained.

### TECHNICAL FIELD

The present disclosure relates generally to a method to recover energy of a hydraulic motor. More specifically, the present disclosure relates to energy recovery during a motor reverse event.

### BACKGROUND

Construction machines frequently use hydraulic systems that provide control of various aspects of the machine. Typically, such machines employ multiple fluid pressurizing pumps (simply referred to as pumps) to provide hydraulic power to accomplish a variety of machine functions. Such applications may pertain to fan-drive systems, steering systems, braking systems, propulsion systems, swing systems, and/or the like. For example, in fan-drive systems the pump may drive a motor of a cooling fan to facilitate circulation of air around the engine, thus dissipating heat from the engine's compartment. Applications may use the airflow via the fan-drive system to cool a radiator as well.

Such a fan-drive system may be controlled or altered periodically to reverse a rotation of the cooling fan. Reverse rotation may assist in the removal of debris which generally accumulate during a forward airflow. Debris may be removed from the radiator, engine compartment, associated filters, airflow screens, and/or the like. In this manner, airflow passages become much cleaner.

Such mechanisms in machines have conventionally been provided with a reversibility function of the fan, or the fan's motor. In typical implementations, however, a reversal of angular momentum causes a residual motion in the rotating fan, which has been observed to induce vacuums within the hydraulics of the fan-drive system. Such vacuums may introduce cavitation within the hydraulics system, which may prove detrimental. Additionally, a sudden change in flow direction by the control of valve can cause relatively damaging pressure spikes and excessive heat.

U.S. Pat. No. 8,490,739 discloses a unitized vehicle drive system that provides both hydraulic energy storage and recovery along with a direct mechanical drive mode for maximum fuel consumption efficiency, throughout the vehicle's duty cycle. Although this reference discloses a hydraulic energy storage and recovery system, no solution exists to recover energy during a motor reverse event.

Accordingly, the system and method of the present disclosure solves one or more problems set forth above and/or other problems in the art.

### SUMMARY OF THE INVENTION

Various aspects of the present disclosure illustrate a method to recover energy in a reversible hydraulic motor system during a motor reverse event. The method includes provision of a pivotal movement of a swashplate of a hydraulic motor over a center position, while the hydraulic motor rotates in a first direction. The hydraulic motor at this stage may be due to receive a pressurized fluid from a pump. Next, by de-stroking the pump, a flow of the pressurized fluid to the hydraulic motor is restricted. A valve is then positioned in a charge position to store the pressurized fluid into an accumulator. Thereafter, the stored pressurized fluid is discharged from the accumulator to the hydraulic motor as the hydraulic motor begins rotation in an opposite, second direction. A positioning of the valve to a block position inhibits the flow of the pressurized fluid into or out of the accumulator. Thereafter, up-stroking the pump facilitates a continued rotation of the hydraulic motor in the opposite, second direction.

Another aspect of the present disclosure describes an energy recovery system for a reversible hydraulic motor system. The energy recovery system includes a pump to pressurize fluid, a hydraulic motor to receive the pressurized fluid from the pump and rotate in a first direction, and an accumulator, which is in selective fluid communication with the hydraulic motor and the pump. The accumulator is configured to store the pressurized fluid. Further, a valve is structured and arranged to facilitate the storage and discharge of the stored, pressurized fluid of the accumulator. Moreover, a controller is coupled to the valve. During a reverse motor command, the controller is configured to pivot a swashplate of the hydraulic motor over a center position when rotation of the hydraulic motor is in the first direction. Thereafter, the controller manipulates the valve to a position to facilitate storage of the pressurized fluid into the accumulator. Subsequently, the valve is moved to a position to facilitate discharge of the stored pressurized fluid from the accumulator to the hydraulic motor as the hydraulic motor begins to rotate in an opposite, second direction. Finally, the valve is moved to a block position to inhibit flow of the pressurized fluid into or out of the accumulator.

### BRIEF DESCRIPTION OF THE DRAWINGS

FIG. 1 is a side view of an exemplary machine that employs a reversible hydraulic motor system, in accordance with the concepts of the present disclosure;

FIG. 2 is a schematic view of the reversible hydraulic motor system of FIG. 1 that employs an energy recovery system, in accordance with the concepts of the present disclosure;

FIG. 3 is a schematic view of the reversible hydraulic motor system, in deployment with an alternate configuration of the energy recovery system of FIG. 2, in accordance with the concepts of the present disclosure; and

FIG. 4 is a flowchart that illustrates an exemplary method to recover energy in the reversible hydraulic motor system during a motor reverse event, in accordance with the concepts of the present disclosure.

### DETAILED DESCRIPTION

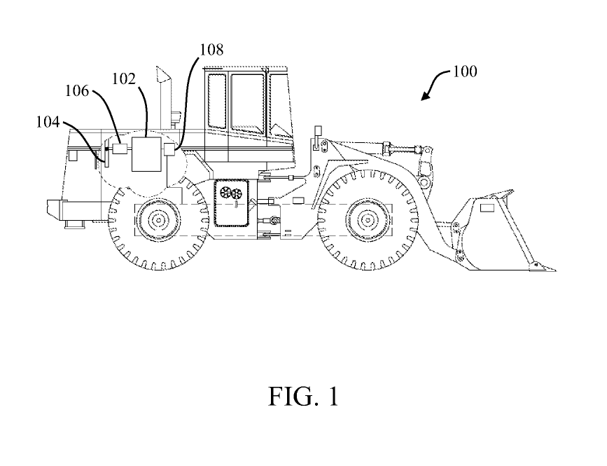

Referring to FIG. 1, there is shown an exemplary machine 100, such as a wheel loader. The machine 100 may embody a tracked-type configuration as well. The present disclosure also contemplates its application to other mobile machines, such as backhoe loaders, compactors, feller bunchers, track-type tractors, forest machines, industrial loaders, skid steer loaders, mining vehicles, and/or excavators. An extension of the disclosed application may also be applicable to stationary machines, such as power-generation systems and other electric power-generating machines. An application to residential and commercial establishments, as well as to machines that are applicable for daily use may be contemplated.

The machine 100 may include an engine 102, configured to run the machine 100. The engine 102 may also power a fan-drive system 104, alongside a variety of other engine applications. The fan-drive system 104 may be operably coupled with the engine 102 via a reversible hydraulic motor system 106. The reversible hydraulic motor system 106 may assist the fan-drive system 104 to run selectively in a direction opposite to a general operation direction, which may further facilitate a reversal in the general workability of the machine 100. Related controls may be provided by an engine controller 108.

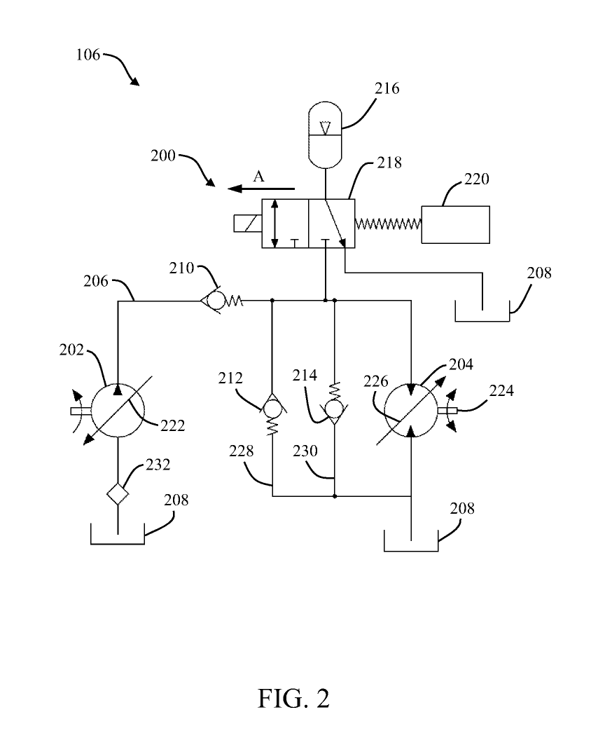

Referring to FIG. 2, there is shown a schematic of the reversible hydraulic motor system 106. The reversible hydraulic motor system 106 includes an energy recovery system 200. The energy recovery system 200 includes a pump 202 and a hydraulic motor 204. The pump 202 and the hydraulic motor 204 are fluidly connected by means of an open-loop circuit 206. The open-loop circuit 206 facilitates passage and an eventual delivery of a pressurized fluid into one or more fluid tanks 208. A check valve 210 is positioned to allow a flow of the pressurized fluid from the pump 202 towards the hydraulic motor 204. Further, a relief valve 212 and an anti-cavitation valve 214 may be operably positioned with the open-loop circuit 206 as well. The energy recovery system 200 may also include an accumulator 216, a valve 218, and a controller 220, which controls a position of the valve 218. Additionally, a filter 232 may be positioned as part of the reversible hydraulic motor system 106 to screen the open-loop circuit 206 of debris and other unwanted particles.

The pump 202 may be configured to pressurize fluid that flows within the reversible hydraulic motor system 106. The pump 202 may be a swashplate-type pump and may include multiple piston bores (not shown), which contain pistons (not shown) that manipulate relative to a tiltable pump swashplate 222. The pump 202 may facilitate a unidirectional flow of pressurized fluid to the hydraulic motor 204. It is contemplated that pump 202 may be an over-center-type pump or be rotatable in either directions, as desired. The pump 202 may also be of a fixed displacement type paired with a valve to control the amount of flow directed to the hydraulic motor 204.

The hydraulic motor 204 may be a reversible-type motor, fluidly coupled to the pump 202, and may receive pressurized fluid from the pump 202 to rotate in a first direction. The hydraulic motor 204 may convert the pressurized fluid from pump 202 into a rotational output of an output shaft 224, which may be a bi-directional shaft. In an embodiment, hydraulic motor 204 may be a fixed or variable displacement-type motor. As a variable displacement motor, the hydraulic motor 204 may include multiple piston bores (not shown), which contain pistons (not shown) that manipulate against a fixed or rotatable motor swashplate 226. Further, an angular setting of the motor swashplate 226, relative to the pistons, may be facilitated by an actuator (not shown), such as one driven by a servo motor.

The hydraulic power supplied may be selectively routed to the various components of the energy recovery system 200 via a network of valves. Such valves may include the check valve 210, the relief valve 212, and the anti-cavitation valve 214. Although not limited, each of these valves may be unidirectional valves, selected from among the commonly known devices in the art.

The check valve 210 may be positioned to route an incoming pressurized fluid flow from the pump 202 to the hydraulic motor 204, as already noted. In the disclosed configuration, however, the check valve 210 inhibits a reverse flow of the pressurized fluid from the hydraulic motor 204 to the pump 202.

The relief valve 212 may be positioned along a relief channel 228 of the open-loop circuit 206 to provide relief to the hydraulic motor 204 and the open-loop circuit 206 from an overly pressurized fluid volume. During the event of a pressure spike, overly pressurized fluid volume may travel through the relief channel 228 and be delivered into the fluid tank 208, without having to pass through the hydraulic motor 204. In an embodiment, the relief valve 212 may be compatible to relieve the open-loop circuit 206 of pressure spikes in excess of 20000 Kilopascal (kpa). Such pressure spikes may occur during a motor reverse event. Other pressure values may be contemplated without deviating from the scope of the disclosure.

The anti-cavitation valve 214 may be positioned within an auxiliary passage 230 of the open-loop circuit 206. Although not limited, the anti-cavitation valve 214 may be a check valve restricted to accommodate a relatively modest pressure difference of around 100 kpa, as compared to the restriction imparted by the relief valve 212. The anti-cavitation valve 214 is configured to prevent the effects of cavitation within the open-loop circuit 206. When the pressure difference across the anti-cavitation valve 214 exceeds the spring force, flow through anti-cavitation valve 214 supplements the flow from pump 202. This typically occurs when the rotational velocity of the hydraulic motor 204 consumes more flow than the pump 202 can provide. In general working, a fluid volume relieved through the anti-cavitation valve 214 may return to operably flow within the open-loop circuit 206, to run the hydraulic motor 204.

The accumulator 216 may form a portion of the open-loop circuit 206 and a substantially pertinent portion of the energy recovery system 200. The accumulator 216 may be in selective fluid communication with the hydraulic motor 204 and the pump 202. In so doing, the accumulator 216 may be configured to store at least a portion of the flowing pressurized fluid during operations. More particularly, the accumulator 216 may be a pressure storage reservoir or an energy storage device, in which the flowing pressurized hydraulic fluid may be stored (at least temporarily) under pressure by an external source. As an example, external sources may include a spring, a resilient member, a raised weight, or a compressed gas. Further, the accumulator 216 may enable the reversible hydraulic motor system 106 to accommodate optional requirements of applying a relatively less powerful pump 202. In that way, the accumulator 216 may respond more quickly to a temporary power demand, for example when initiating a reversal of the hydraulic motor 204, thus smoothening out pulsations of a related fluid flow.

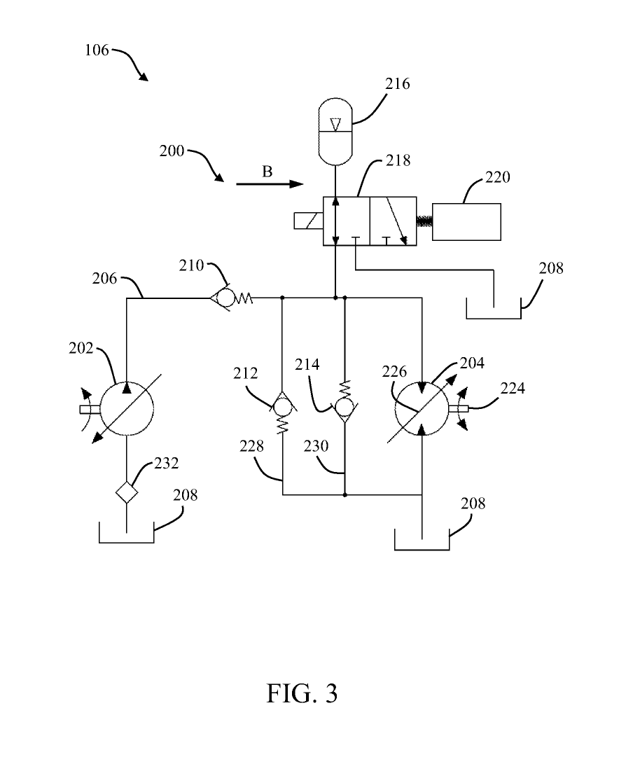

The valve 218 may be a reversible 2-position 3-way charge valve structured and arranged to facilitate the storage and discharge of the pressurized fluid within the accumulator 216. The valve 218 may be a spool valve, although other valve types may be contemplated. In application, the valve 218 may be configured to alter between an extended position and a retracted position. By implication, the valve 218 may vary between a charge position, a discharge position, and a block position. The charge position and the discharge position may be substantially the same position of the valve 218, as shown in FIG. 3. Conversely, the block position may establish a variation in the valve's position. More specifically, the block position may be established in an extended state (direction, A) of the valve 218, as shown in FIG. 2, which may differ from the charge and discharge positions that complement a retracted state (direction, B), as illustrated in FIG. 3. In the charge and the discharge position, the valve 218 may facilitate the accumulator 216 to be in fluid communication with the open-loop circuit 206. In the block position, however, the valve 218 may fluidly disconnect the accumulator 216 from the open-loop circuit 206. In an embodiment, twin valves may perform the functionality of the charge position and the discharge position. Other configurations may also be contemplated.

The controller 220 may be operably coupled to the valve 218 and to the hydraulic motor 204. The controller 220 may be one among the known control devices used in the art. For example, the controller 220 may be a microprocessor-based device configured to receive relay signals from a sensing device or an output device, which prescribe a reversal of a rotation of the hydraulic motor 204. In an embodiment, the sensing device or an output device may be the engine controller 108 (see FIG. 1). More particularly, the controller 220 may include a set of volatile memory units, such as RAM and/or ROM, which include associated input and output buses. In addition, the controller 220 may be envisioned as an application-specific integrated circuit, or a known logic device, which provide controller functionality, and such devices being known to those with ordinary skill in the art. In an embodiment, the controller 220 may form a portion of the electronic control unit of the engine 102 (see FIG. 1), or may be configured as a stand-alone local entity.

The controller 220 may include a memory unit to store information relative to the requirements of a motor reverse event. For example, a time pattern may be set according to the direction to which the hydraulic motor 204 may subsequently switch. Such time patterns may be stored within the memory. Further, algorithms related to such functionalities may be stored within the controller 220. In an embodiment, the controller 220 may be hydraulically or pneumatically operable.

Based on the input received, the controller 220 may be configured to pivot the motor swashplate 226 by known means. Further, the controller 220 may also be configured to change or switch the position of the valve 218 relative to the accumulator 216. More specifically, such a change in the position of the valve 218 may selectively allow the accumulator 216 to either be in fluid communication or disconnected from the open-loop circuit 206. Such positioning may facilitate both a storage (charge) and release (discharge) of the pressurized fluid within the accumulator 216. In a block position, the controller 220 may inhibit a pressurized fluid flow from entering or flowing out of the accumulator 216.

Referring to FIG. 3, an alternate configuration of the energy recovery system 200 within the reversible hydraulic motor system 106 is shown. The alternate configuration may include a movement or a manipulation of the valve 218 relative to the accumulator 216 and the open-loop circuit 206. The movement, facilitated through the controller 220, may be visualized through the noted direction, B, which corresponds to the valve 218 being in a retracted state. The retraction may be better visualized when FIG. 2 and FIG. 3 are viewed in conjunction with each other. Effectively, direction, B, depicts a movement of the valve 218 in a direction opposite to the direction, A, which enables fluid communication between the accumulator 216 and the open-loop circuit 206.

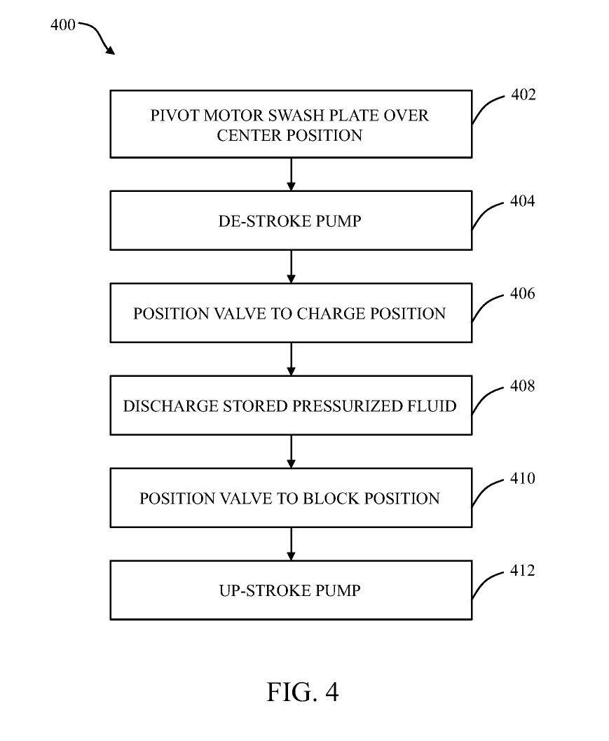

Referring to FIG. 4, a flowchart 400 illustrates an exemplary methodology that may be employed for the energy recovery system 200. Flowchart 400 is discussed in connection with FIGS. 2 and 3. Notably, the flowchart 400 describes an exemplary event in the reversible hydraulic motor system 106, where a reverse operation of the hydraulic motor 204 is required, and when energy in the open-loop circuit 206 is temporarily stored.

The method to recover energy initiates at step 402. At step 402, the motor swashplate 226 is pivoted over a center position, while the hydraulic motor 204 rotates in a first direction. At step 402, the hydraulic motor 204 is due to receive a pressurized fluid from the pump 202. The method proceeds to step 404.

At step 404, by de-stroking the pump 202 a flow of the pressurized fluid to the hydraulic motor 204 is restricted. This occurs when a reversal of the hydraulic motor 204 is required. The method proceeds to step 406.

At step 406, the valve 218 is manipulated to a charge position (retracted state in the direction, B) to store the pressurized fluid into the accumulator 216. The method proceeds to step 408.

At step 408, once the fan speed reaches near zero and the output shaft 224 (and the hydraulic motor 204) initiates rotation in an opposite, second direction, the stored pressurized fluid within the accumulator 216 is discharged to the hydraulic motor 204. The method proceeds to step 410.

At step 410, the valve 218 is moved to the block position to inhibit a further flow of the pressurized fluid into or out of the accumulator 216. This state may be maintained until a subsequent reversal of the direction of the hydraulic motor 204 is required. The method proceeds to end step 412.

At end step 412, by up-stroking the pump 202 a continuous rotation of the hydraulic motor 204 in the opposite, second direction, is maintained.

### INDUSTRIAL APPLICABILITY

Within the pump 202, pistons (not shown) may reciprocate in the bores (not shown) to produce a pumping action as the pump swashplate 222 rotates relative to the bores. Alternatively, the pistons and bores may collectively rotate while pump swashplate 222 remains stationary. Upon a requirement, the pump swashplate 222 may be selectively tilted relative to a longitudinal axis of the pistons to vary displacement of the pistons within the respective bores. This may correspondingly vary an output of the pump 202.

Within the hydraulic motor 204, pressurized fluid may be allowed to enter the bores (not shown) to force a movement of pistons (not shown) towards the motor swashplate 226. As the pistons press against the motor swashplate 226, the motor swashplate 226 may be urged to rotate relative to the pistons. At least one of a configuration is maintained—one, where the motor swashplate 226 rotates while the pistons remain stationary; and another, where the pistons rotate while motor swashplate 226 remains stationary. Energy of the resultant incoming pressurized fluid is converted into a rotational output. Further, an angle of motor swashplate 226 may determine an effective displacement of the pistons relative to the bores of hydraulic motor 204. As the motor swashplate 226 continues to rotate relative to the pistons, the working fluid may be discharged from each bore to the fluid tank 208. An operation of the hydraulic motor 204 is thus attained in a forward direction.

In operation, a receipt of a motor reverse command from a sensing device or an output device (such as the engine controller 108) may prompt the controller 220 to pivot a motor swashplate 226 of the hydraulic motor 204. The pivotal operation may be performed over a center position when rotation of the hydraulic motor 204 is in the first direction. Simultaneously, the controller 220 also positions the valve 218 to a charge position (see FIG. 3) that facilitates diversion and storage of the pressurized fluid into the accumulator 216. Such a diversion is facilitated by the check valve 210, which prevents the flow from returning to the pump 202.

At this stage, the accumulator 216 being at a relatively low pressure facilitates absorption (or intake) of a substantial volume of the flowing pressurized fluid. Once the hydraulic motor 204 slows to a stop, the stored pressurized fluid may be discharged to initiate a reverse operation in the opposite, second direction. The controller 220 may position the valve 218 to a discharge position (achieved by maintaining the same position as the charge position of FIG. 3) to facilitate a discharge of the stored pressurized fluid of the accumulator 216 to the hydraulic motor 204. Once the hydraulic motor 204 starts to fully operate in the opposite, second direction, the controller 220 may return the valve 218 to a block position (see FIG. 2) to inhibit further flow of the pressurized fluid into or out of the accumulator 216. Simultaneously, the pump 202 is operated to supply energy for a consequent rotation of the hydraulic motor 204. This position may be maintained until a next motor reverse event is initiated.

A lag between the movement of the motor swashplate 226 over center and the delay in the reversal of the output shaft 224 may occur given a load of output, or the fan-drive system 104 (see FIG. 1). During the lag, pressure spikes accompanying the flow reversal may be at least partially relieved through the relief valve 212, while also a considerable portion of pressurized fluid enters and is stored in the accumulator 216. Apart from the pressure spike, a consequent heat generation is restricted as well.

The energy recovery system 200 need not be viewed as being restricted to applications that employ the over-center type hydraulic motor 204 alone. Instead, energy may be captured likewise for multiple applications, such as conventional fan drive circuits that employ an arrangement of the valve 218 and the accumulator 216, as disclosed. Although energy storage and recovery described here assists in a forward-to-reverse direction switch, embodiments may also be contemplated where a reverse-to-forward direction switch is being equivalently provided. Further, stored energy may be recovered and used for other systems and sub-systems too, such as for being a source of pilot oil, and the like.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method for recovering energy in a reversible hydraulic motor system during a motor reverse event, the method comprising:
pivoting a swashplate of a hydraulic motor over a center position when the hydraulic motor is rotating in a first direction due to receiving a pressurized fluid from a pump;
de-stroking the pump to limit the pressurized fluid to the hydraulic motor;
positioning a valve to a charge position to store the pressurized fluid into an accumulator;
discharging the stored pressurized fluid of the accumulator to the hydraulic motor as the hydraulic motor begins rotating in an opposite, second direction;
positioning the valve to a block position to inhibit flow of the pressurized fluid into or out of the accumulator; and
up-stroking the pump to continuing rotating the hydraulic motor in the opposite, second direction.

2. An energy recovery system for a reversible hydraulic motor system, the energy recovery system comprising:
a pump to pressurize fluid;
a hydraulic motor to receive the pressurized fluid from the pump to rotate in a first direction;
an accumulator in selective fluid communication with the hydraulic motor and the pump, the accumulator configured to store pressurized fluid;
a valve structured and arranged to facilitate the storage and discharge of stored pressurized fluid of the accumulator; and
a controller coupled to the valve and, and during a reverse motor command, configured to:
pivot a swashplate of the hydraulic motor over a center position when rotation of the hydraulic motor is in the first direction;
position the valve to a position to facilitate storage of the pressurized fluid into the accumulator;
position the valve to a position to facilitate discharge of the stored pressurized fluid of the accumulator to the hydraulic motor as the hydraulic motor begins to rotate in an opposite, second direction; and
position the valve to a block position to inhibit flow of the pressurized fluid into or out of the accumulator.
